(19) United States
(12) Patent Application Publication
(10) Pub. No.: US 2007/0115885 A1
(43) Pub. Date: May 24, 2007

(54) Method and system for fast IP handoff of a mobile node

(76) Inventors: Ajoy K. Singh, Round Lake, IL (US); Kadathur S. Natarajan, Wilmette, IL (US)

Correspondence Address: MOTOROLA, INC., 1303 EAST ALGONQUIN ROAD, IL01/3RD, SCHAUMBURG, IL, 60196, US

(21) Appl. No.: 11/285,326

(22) Filed: Nov. 22, 2005

(51) Int. Cl. H04Q 7/00

(52) U.S. Cl. 370/331; 370/352

(57) ABSTRACT

A method and system for fast IP handoff of a mobile node (MN) (102) from a first wireless network (106) to a second wireless network (108) is disclosed. The method includes releasing (402) a tunnel between a first access router (AR) (204) and a second FA (206), based on at least one predefined criterion. The method also includes initializing (404) a mobile IP registration procedure with the second FA. The mobile registration procedure is performed by the MN.

### FIELD OF THE INVENTION The present invention relates to the field of mobile communication and more specifically, to fast IP handoffs of mobile nodes.

### BACKGROUND

When an electronic device such as a mobile node (MN) using packet data connection moves from a first wireless network to a second wireless network, it may be handed over from the first wireless network to the second wireless network. This is known as IP handoff or Mobile/IP handoff. When IP handoff is performed in such a way that the end user does not notice the impact on quality of real time traffic during the critical path of handoff, the handoff is referred to as fast handoff of the MN. To support this handoff, each wireless network has an access router (AR) associated with it. For example, the first wireless network is associated with a first access router, and the second wireless network is associated with a second access router. The access router performs the function of a mobility agent, to support the mobility of the MN from the first wireless network to the second wireless network, which is known as network layer mobility. In the case of a fast IP handoff between the ARs, also called an inter-AR handoff, the mobility agent for the MN changes from a first AR to a second AR.

The inter-AR handoff of an MN requires the establishment of a wireless link layer connection between an MN and the second access router and the subsequent establishment of a bi directional edge tunnel between the second access router and the first access router over an existing wired link. The tunnel is established to avoid performing Mobile/IP registration during the critical path of handoff. The tunnel enables the transfer of data packets between the first wireless network and second wireless network. The first network receives data packets from the CN and forwards the packets to the second wireless access router that in turn are delivered to the MN over the newly established link layer connection of the second network, and vice versa.

The establishment of the bidirectional tunnel between access routers reduces packet loss as well as packet delay during IP layer handoff. However, the establishment of the tunnel also results in a non-optimal routing and poor utilization of the resources of the access router. The problem of non-optimal routing is introduced due to the addition of the routing segment between the first AR and the second AR. This requires the first AR and the second AR to process data packets originating at the MN and the CN.

Known methods for solving these problems are mentioned in a standard published by the 3^{rd} Generation Partnership Project 2 entitled “CDMA2000 Wireless IP Network Standard: Simple IP and Mobile IP Services”, and in a memo published by the Network Working Group entitled “Low Latency Handoffs in Mobile IPv4”. These methods state ways of tearing down a tunnel after a period and renewing the tunnel prior to that period. However these methods do not specify any criteria for fast handoff tunnel teardown.

### BRIEF DESCRIPTION OF THE DRAWINGS

Various embodiments of the invention will hereinafter be described in conjunction with the appended drawings, provided to illustrate and not to limit the invention, wherein like designations denote like elements, and in which:

FIG. 1 illustrates an exemplary environment, in accordance with some embodiments of the present invention;

FIG. 2 illustrates a block diagram of network architecture in a fast IP handoff, in accordance with some embodiments of the present invention;

FIG. 3 is a block diagram of an access router (AR), in accordance with some embodiments of the present invention;

FIGS. 4 and 5 show a flowchart illustrating a method of fast IP handoff of the MN, from the first wireless network b the second wireless network, in accordance with some embodiments of the present invention; and

FIG. 6 is a flow chart, illustrating a method of determining release of a tunnel established between a first access router and a second access router, in accordance with some embodiments of the present invention.

### DETAILED DESCRIPTION

Before describing in detail the particular fast mobile IP handoff method and system in accordance with the present invention, it should be observed that the present invention resides primarily in combinations of method steps and system components related to fast mobile IP handoff technique. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

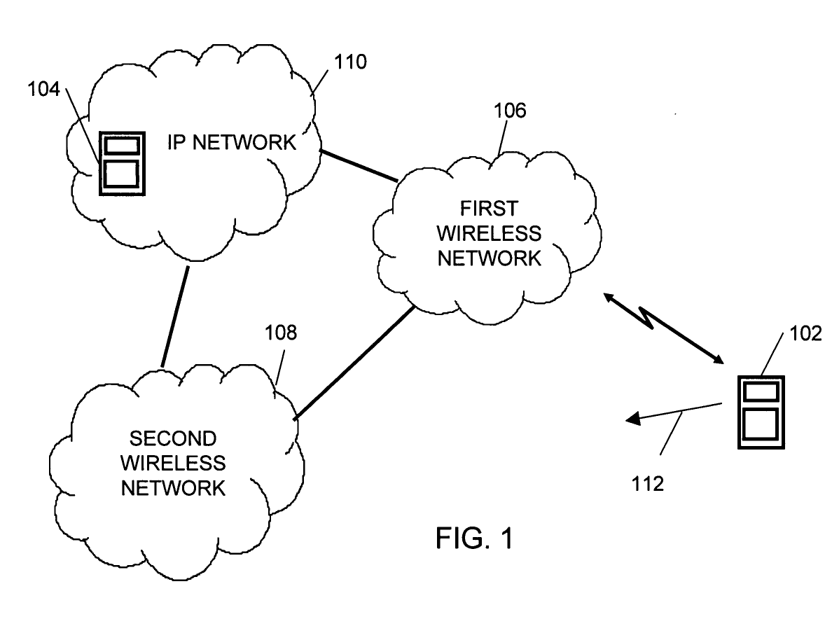

Referring to FIG. 1, an exemplary wireless network environment is shown, in accordance with some embodiments of the present invention. A mobile node (MN) 102 is shown to be in communication with a correspondent node (CN) 104 via a first wireless network 106. The present invention is explained with reference to voice over Internet Protocol (VolP) communication. However, it will be apparent to a person skilled in the art that the present invention is equally applicable to other types of communication. The CN 104 operates in an IP network that may be a wired IP network or a wireless IP network. The MN 102 is moving, as illustrated by arrow 112, towards a second wireless network 108. As shown in FIG.1 the MN 102 is presently associated with the first wireless network 106, but a fast handover will be necessary to associate the MN 102 with second wireless network 108 in order to maintain the voice over IP communication without interruption.

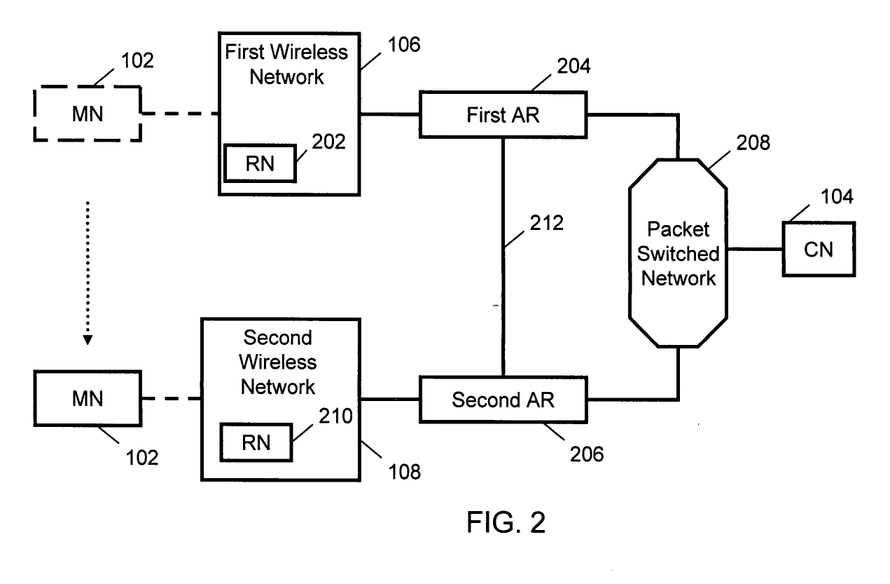

Referring to FIG. 2, a block diagram illustrates the network architecture in a fast IP handoff, in accordance with some embodiments of the present invention. The first wireless network 106 includes a radio network (RN) 202 and is connected to a first access router (AR) 204 that provides routing services to the MN 102 while it is connected with the first wireless network 106. The first AR 204 performs the function of a mobility agent to support the network layer mobility of the MN 102 from the first wireless network 106 to the second wireless network 108. In an embodiment of the present invention, the AR 204 is referred to as a Packet Data Serving Node (PDSN). In another embodiment of the present invention, the AR 204 is referred to as a foreign agent (FA). As explained earlier with reference to FIG. 1, the MN 102 is switched to the second wireless network 108, using a fast IP handoff to maintain IP packet communication with the CN 104. In such an event of a fast IP handoff from the first wireless network 106 to the second wireless network 108, the mobility agent for the MN 102 will be changed from the first AR 204 to the second AR 206, i.e., the MN 102 becomes associated with the second wireless network 108. The second AR 206 provides routing services to the MN 102 while it is attached to the second wireless network 108. In order to provide fast IP handoff, a bidirectional edge tunnel 212, or tunnel 212 as it is referred to hereafter, is established between the first AR 204 and second AR 206. The tunnel 212 provides for routing of the IP packets from the MN 102 to the CN 104 through the second AR 206, the first AR 204 and the packet switched network 208. The tunnel 212 provides for IP packet routing at least until the second AR 206 is registered with the packet switched network 208 as the mobility agent for the MN 102. Embodiments of the present invention implement a tear down of the tunnel 212 and re-registration of the MN 102, for which IP communications are then supported directly by the second AR 206.

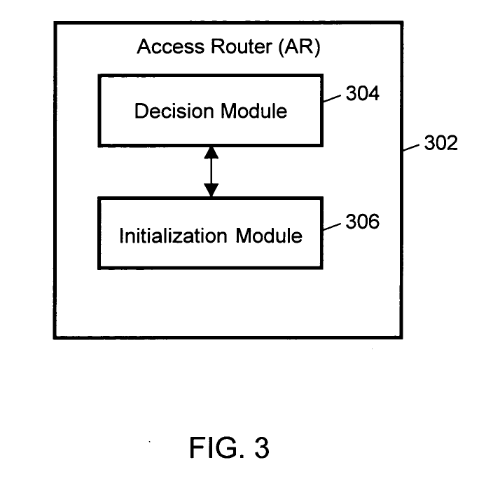

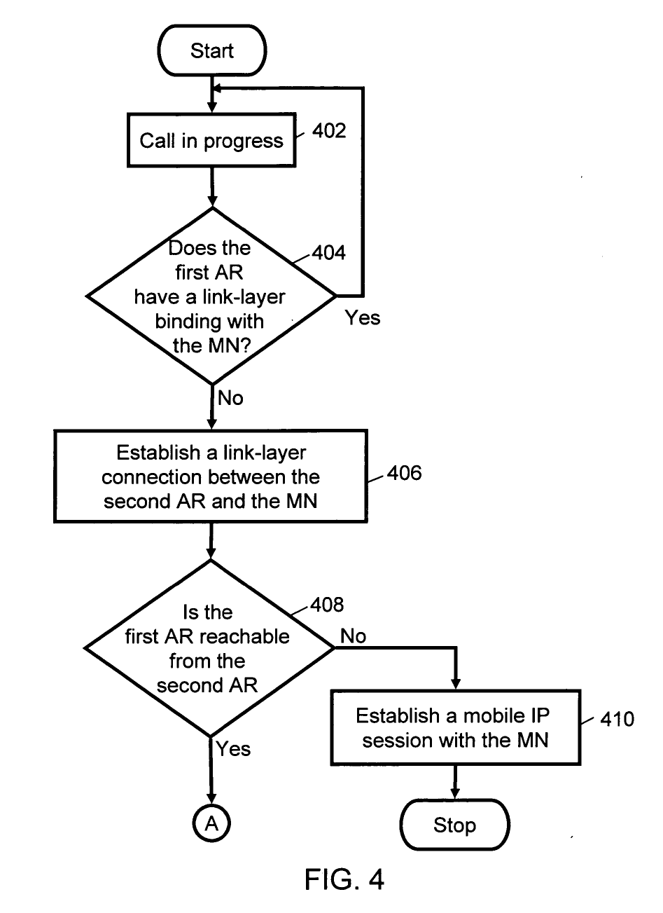

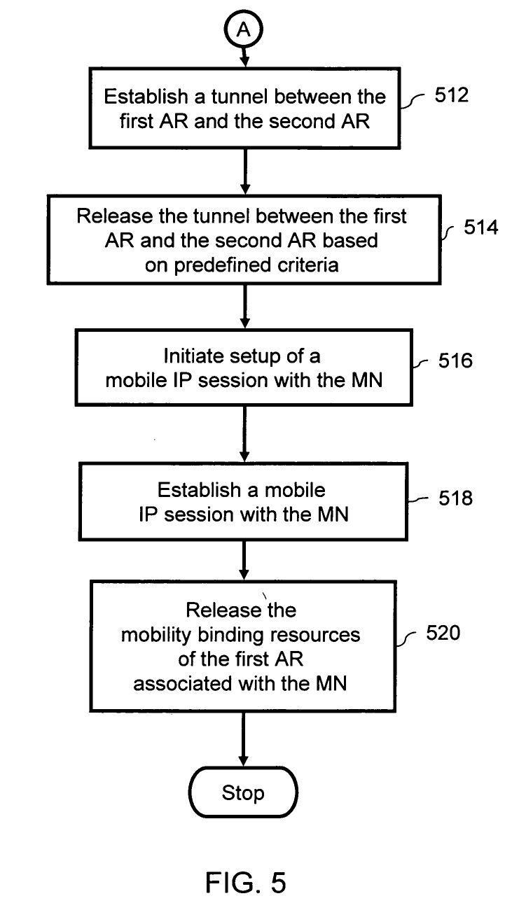

Referring to FIG. 3, a block diagram illustrates an AR 302 used for fast IP handoff of the MN 102, from the first wireless network 106 to the second wireless network 108, in accordance with some embodiments of the present invention. In an embodiment of the present invention, the AR 302 is the first AR 204. In another embodiment of the present invention, the AR 302 is the second AR 206. The AR 302 includes a decision module 304 and an initialization module 306. Certain functions of the AR 302 are explained in conjunction with FIGS. 4 and 5.

Referring to FIGS. 4 and 5, a flowchart illustrates a method for fast IP handoff of the MN 102 from the first wireless network 106 to the second wireless network 108, in accordance with some embodiments of the present invention. At step 402, a communication connection is established between the MN 102 and the CN 104. This signifies that there is a call in progress between MN and CN using a first wireless network. At step 404, it is checked whether the first AR 204 has a link-layer binding with the MN 102. If the first AR 204 has a link-layer binding with the MN 102, step 402 is repeated. However, if the first AR 204 does not have sufficiently reliable link-layer binding with the MN 102, the second AR 206 establishes a link-layer connection with the MN 102, at step 406. At step 408, it is determined whether the first AR 204 is reachable from the second AR 206 that is associated with the second wireless network 108. If the first AR 204 is not reachable from the second AR 206, a mobile IP session is established between the MN 102 and the second AR 206, at step 410 and no further action is taken In this situation, since no tunnel could be established between the first AR 204 and the second AR 206, there may be interruption of audio or loss of the call in a voice IP call.

However, if the first AR 204 is reachable from the second AR 206, the second AR 206 establishes a tunnel with the first AR 204, at step 512. The tunnel allows the transfer of data traffic between the first AR 204 and the second AR 206. At step 514, the tunnel between the first AR 204 and the second AR 206 is released based on predefined criteria. Thereafter, the first AR 204 signals the second AR 206 to initiate the setting up of a mobile IP session with the MN 102, at step 416. At step 418, the second AR 206 initiates a mobile IP session with the MN 102. At step 520, the second AR 206 signals the first AR 204 to release the tunnel between the first AR 204 to the second AR 206.

In some embodiments of the present invention, the predefined criterion is based on the traffic profile of data traffic exchanged between the first AR 204 and the second AR 206. The first AR 204 and the second AR 206 are configured in these embodiments to identify real-time data traffic, based on the traffic profile. The pattern of the traffic is compared with the traffic profile of the real-time data traffic. If the pattern of the traffic does not match the traffic profile of the real-time data traffic, the tunnel between the first AR 204 and the second AR 206 is released.

In yet another embodiment of the present invention, the predefined criterion is based on CPU utilization at the first AR 204. The CPU utilization at the first AR 204 is determined. If CPU utilization exceeds a configurable CPU utilization threshold value, the tunnel between the first AR 204 and the second AR 206 is released. In an embodiment of the present invention, the tunnel release is associated with lower-priority users.

In yet another embodiment of the present invention, the tunnel between the first AR 204 and the second AR 206 is released if the time for which the MN 102 has been registered with one of the first AR 204 and the second AR 206 exceeds a tunnel lifetime of the MN 102. In an embodiment of the present invention, the tunnel lifetime is referred to as a visitor list lifetime. In another embodiment of the present invention, the tunnel lifetime is referred to as a binding cache lifetime.

In a case in which multiple IP sessions or flows associated with a mobile node MN 102 are anchored at the first AR 204, an IP flow/session associated with non-real time traffic can also be selectively transferred from AR 204 to AR 206 without impacting remaining flows associated with the same mobile, in accordance with yet another embodiment of the present invention. The selective transfer of an IP flow associated with MN 102 from first AR 204 to second AR 206 requires support of flow based mobility management by the underlying mobility protocol.

In still another embodiment of the present invention, a tunnel associated with a lower-priority user is released, when buffer utilization at the first AR 204 exceeds a buffer utilization threshold value. The buffering delay is compared to a preconfigured time. Tunnel teardown may be initiated when the data packets are buffered beyond the preconfigured time.

When the tunnel between the first AR 204 and the second AR 206 is released, based on at least one of the predefined criteria discussed above, a mobile IP registration procedure is initialized with the second AR 206, at step 404. In an embodiment of the present invention, the initialization module 306 initializes the mobile IP registration procedure with the second AR 206.

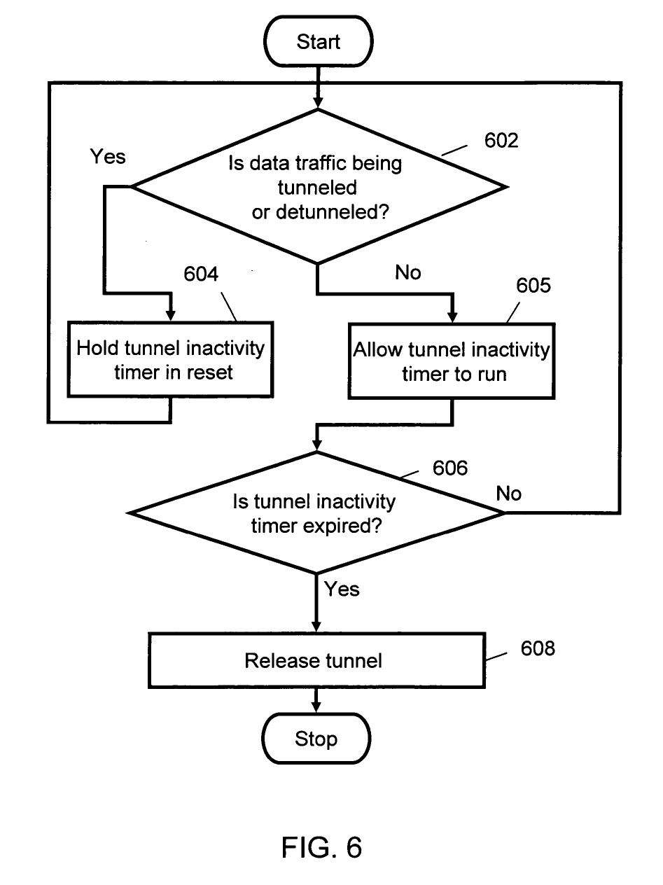

Referring to FIG. 6 a flow chart illustrates a method for determining release of a tunnel established between a first access router and a second access router, in accordance with some embodiments of the present invention. At step 602, a check is made to determine whether data traffic is tunneled or detunneled. In an embodiment of the present invention, the first AR 204 and the second AR 206 perform simultaneous tunneling and de-tunneling of data traffic. In another embodiment of the present invention, the first AR 204 tunnels data traffic and the second AR 206 de-tunnels it This other embodiment can happen in case of a streaming application or when downlink traffic gets tunneled and uplink traffic is sent using an optimized route (MN—second AR—CN). In yet another embodiment of the present invention, the first AR 204 de-tunnels data traffic and the second AR 206 tunnels it. For any of these embodiments, a tunnel release criteria may be used that is based on tunnel inactivity. Tunnel inactivity may be measured using an inactivity timer. The tunnel inactivity timer is held in reset, or initialized, at step 604 while the tunnel is determined to be active during monitoring step 602 (packets are being tunneled or detunneled). When the tunnel is determined to be inactive at step 602, the inactivity timer is no longer held in reset, and allowed to time the inactivity at step 605. When the inactivity timer is determined not to have expired at step 606, monitoring of the tunnel activity continues at step 602. When the inactivity timer is determined to have expired at step 606, release of the tunnel is initiated at step 608.

It will be appreciated that the fast IP handoff described herein may be comprised of one or more conventional processors and unique stored program instructions that control the one or more processors to implement some, most, or all of the functions described herein; such as, releasing the tunnel between the first access router and the second access router. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

The method for fast IP handoff of a MN, described herein, can be applied to IEEE 802.16, IEEE 802.20, CDMA, HSDPA and other technologies using Mobile/IP Fast Handoff protocol.

In the foregoing specification, the present invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises”, “comprising”, “includes”, “including” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another”, as used herein, is defined as at least a second or more. The term “having”, as used herein, is defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for fast Internet Protocol (IP) handoff of a mobile node (MN) from a first wireless network to a second wireless network, the method comprising:
releasing a tunnel between a first access router (AR) and a second AR based on at least one predefined criterion, wherein the first AR is associated with the first wireless network and the second AR is associated with the second wireless network; and
initializing a mobile IP registration procedure with the second AR, the mobile IP registration procedure being performed by the MN.

2. The method according to claim 1, wherein determining a predetermined criterion of the at least one predefined criterion comprises initializing at least one tunnel inactivity timer when one of the first AR and the second AR performs one of tunneling data traffic and de-tunneling data traffic, data traffic being exchanged between the MN and a correspondent node (CN).

3. The method according to claim 2 further comprising comparing a tunnel inactivity time with a predetermined value, the tunnel inactivity time being a time during which data traffic is not transferred through the tunnel.

4. The method according to claim 1, wherein determining a predetermined criterion of the at least one predefined criterion comprises configuring the first AR and the second AR with a traffic profile to identify real-time data traffic.

5. The method according to claim 5 further comprising comparing data traffic routed from the first wireless network to the second wireless network with the traffic profile.

6. The method according to claim 1, wherein determining a predetermined criterion of the at least one predefined criterion comprises determining CPU utilization at the first AR.

7. The method according to claim 7 further comprising comparing the CPU utilization with a configurable CPU utilization threshold value.

8. The method according to claim 8 further comprising determining whether the tunnel is associated with a low priority user.

9. The method according to claim 1, wherein determining a predetermined criterion of the at least one predefined criterion comprises determining a time for which the MN has been registered with one of the first AR and the second AR.

10. The method according to claim 10 further comprising comparing the time with a tunnel lifetime of the MN.

11. The method according to claim 1, wherein determining a predetermined criterion of the at least one predefined criterion comprises determining buffer utilization at the first AR.

12. The method according to claim 11 further comprising comparing the buffer utilization with a buffer utilization threshold value.

13. The method according to claim 11 further comprising comparing a buffering delay with a preconfigured time.

14. The method according to claim 13 further comprising determining whether the tunnel is associated with a low priority user.

15. An access router (AR), the AR configured to:
release a tunnel between two ARs based on at least one predefined criterion; and
initialize a mobile IP registration procedure, the mobile IP registration procedure being performed by a mobile node (MN).

16. The AR according to claim 15 wherein the at least one predefined criterion is selected from a group comprising:
determining whether a time for which the tunnel has been inactivity exceeds a predetermined value;
determining whether data traffic between the two ARs is real time data traffic;
determining whether CPU utilization at the AR exceeds a configurable CPU utilization threshold value;
determining whether a time for which the MN has been registered with one of the two ARs exceeds a tunnel lifetime of the MN; and
determining whether buffer utilization at the AR exceeds a buffer utilization threshold value.
